(19) United States
(12) Patent Application Publication
(10) Pub. No.: US 2026/0234037 A1
(43) Pub. Date: Aug. 13, 2026

(54) METHOD FOR REMOVING DIVALENT INORGANIC MERCURY

(71) Applicant: Northwest Institute of Plateau Biology, CAS, Xining, Qinghai (CN)

(72) Inventors: Ming ZHANG, Xining, Qinghai (CN); Lixin WEI, Xining, Qinghai (CN); Hongtao BI, Xining, Qinghai (CN)

(73) Assignee: Northwest Institute of Plateau Biology, CAS, Xining, Qinghai (CN)

(21) Appl. No.: 18/690,196

(22) PCT Filed: Nov. 29, 2023
(86) PCT No.: PCT/CN2023/135032

§ 371 Date: Mar. 7, 2024

(30) Foreign Application Priority Data
Nov. 3, 2023 (CN) 202311451182.X

(51) Int. Cl. C02F 1/52; C02F 1/66; C02F 101/20

(52) U.S. Cl. CPC C02F 1/5236; C02F 1/66; C02F 2101/20

(57) ABSTRACT

Disclosed is a method for removing a divalent inorganic mercury, belonging to the technical field of mercury treatment. The method includes: mixing a mercapto reagent, a sulfur powder, and a matrix with the divalent inorganic mercury to be removed to obtain a mixture, and subjecting the mixture to reaction at a pH value of 3 to 10, wherein the mercapto reagent includes at least one of 2-mercaptoethanol, cysteine, and glutathione. Divalent sulfide ions are generated from elemental sulfur powder, and combine with divalent mercury ions to form a mercury sulfide precipitation, thereby achieving the treatment of mercury pollution related to the divalent mercury ions.

### CROSS REFERENCE TO RELATED APPLICATION

The present application is a national stage application of International Patent Application No. PCT/CN2023/135032, filed on Nov. 29, 2023, now pending, which claims priority to the Chinese Patent Application No. CN202311451182.X, filed with the China National Intellectual Property Administration on Nov. 3, 2023, and entitled “METHOD FOR REMOVING DIVALENT INORGANIC MERCURY”. The disclosure of the two applications is incorporated by references herein in their entireties as part of the present application.

### TECHNICAL FIELD

The present disclosure relates to the technical field of mercury treatment, and in particular to a method for removing a divalent inorganic mercury.

### BACKGROUND

Adsorption of mercury has caused ubiquitous mercury contaminations, such as mercury contamination in production equipment of mercury-containing preparations in traditional medicines and pipeline contamination caused by high-mercury-content samples in mercury content analysis. In the existing technology, adsorbed mercury is generally removed with hydrochloric acid or nitric acid of relatively high concentrations. For example, MU Yi et al. disclosed mercury removal by hydrochloric acid adsorption (Mu Yi et al. Experimental study on mercury removal from by-product hydrochloric acid by adsorption method, Polyvinyl Chloride, 2015, 43(10): 13-14.), and XIE Hongying disclosed use of a HNO₃—HCl system in treating mercury in turbid water by digestion method (XIE Hongying. Use of HNO₃—HCl system in treating mercury in turbid water by digestion method, North China Journal of Geology and Mineral Resources, 1996, 11(2): 2.). However, high-concentration hydrochloric acid and nitric acid may cause corrosiveness, safety risk, and reagent control problems.

The principle of treating mercury waste liquid mainly lies in using soluble sulfides to convert soluble mercury into extremely-insoluble mercury sulfide. The soluble sulfides are strongly alkaline and could form soluble polysulfide with divalent mercury ions, and could not achieve efficient treatment of the mercury waste liquid.

### SUMMARY

In view of this, an object of the present disclosure is to provide a method for removing a divalent inorganic mercury. In the present disclosure, the use of a mercapto reagent and a sulfur powder realizes efficient removal of the divalent inorganic mercury under a mild pH value.

To achieve the above object, the present disclosure provides the following technical solutions.

The present disclosure provides a method for removing a divalent inorganic mercury, including the following steps:

mixing a mercapto reagent, a sulfur powder, and a matrix with the divalent inorganic mercury to be removed to obtain a mixture, subjecting the mixture to reaction at a pH value of 3 to 10, wherein the mercapto reagent includes at least one selected from the group consisting of 2-mercaptoethanol, L-cysteine, and glutathione.

In some embodiments, subjecting the mixture to reaction is performed at the pH value of 6 to 10.

In some embodiments, a molar ratio of a mercapto group in the mercapto reagent to Hg²⁺ in the matrix with the divalent inorganic mercury to be removed is in a range of (2.5-3): 1.

In some embodiments, the sulfur powder has a particle size of 3 μm to 300 μm. In some embodiments, the sulfur powder has a particle size of 5 μm to 150 μm.

In some embodiments, a molar ratio of the sulfur powder to Hg²⁺ in the matrix with the divalent inorganic mercury to be removed is in a range of (40-300): 1.

In some embodiments, under the condition that the sulfur powder has a particle size of 3 μm to 5 μm, a molar ratio of the sulfur powder to Hg²⁺ in the matrix with the divalent inorganic mercury to be removed is in a range of (80-120): 1.

In some embodiments, under the condition that the sulfur powder has a particle size of 150 μm to 300 μm, a molar ratio of the sulfur powder to Hg²⁺ in the matrix with the divalent inorganic mercury to be removed is in a range of (240-300):1.

In some embodiments, the pH value is achieved by adding a buffer salt.

In some embodiments, the matrix with the divalent inorganic mercury to be removed is selected from the group consisting of an aqueous solution containing the divalent inorganic mercury, and a material with the divalent inorganic mercury on a surface thereof.

In some embodiments, under the condition that the matrix with the divalent inorganic mercury to be removed is the aqueous solution containing the divalent inorganic mercury, the method further includes
adding the mercapto reagent and the sulfur powder into the aqueous solution containing the divalent inorganic mercury, leaving a resulting mixture to stand to form a mercury sulfide precipitation, and conducting solid-liquid separation.

In some embodiments, under the condition that the matrix with the divalent inorganic mercury to be removed is the material with the divalent inorganic mercury on the surface thereof, the method further includes:
mixing an aqueous solution of a buffer salt with the mercapto reagent to obtain a mercapto reagent solution; and
washing the surface of the material in the mercapto reagent solution, adding the sulfur powder thereto, leaving a resulting mixture to stand to form a mercury sulfide precipitation, and conducting solid-liquid separation.

In some embodiments, under the condition that the matrix with the divalent inorganic mercury to be removed is the material with the divalent inorganic mercury on the surface thereof, the method further includes
mixing an aqueous solution of a buffer salt, the mercapto reagent, and the sulfur powder to obtain a suspension including the sulfur powder and a mercapto compound; and
washing the surface of the material in the suspension including the sulfur powder and the mercapto compound, leaving a resulting mixture to stand to form a mercury sulfide precipitation, and conducting solid-liquid separation.

The present disclosure further provides a method for removing an inorganic mercury from an organic mercury sample, including the following steps: mixing a mercapto reagent, a sulfur powder, and a matrix with a divalent inorganic mercury to be removed to obtain a mixture, subjecting the mixture to reaction at a pH value of 3 to 10, wherein the mercapto reagent includes at least one selected from the group consisting of 2-mercaptoethanol, L-cysteine, and glutathione.

Compared with the prior art, some embodiments of the present disclosure has the following beneficial effects:

The principle of the present disclosure is as follows: divalent sulfide ions are generated from an elemental sulfur powder, which further combine with divalent mercury ions to form a mercury sulfide precipitation, thereby achieving the treatment of mercury pollution related to the divalent mercury ions. Direct use of the elemental sulfur powder in treating the mercury pollution related to the divalent mercury ions shows a low generation efficiency of the divalent sulfide ions. In order to improve the generation efficiency of the divalent sulfide ions from the elemental sulfur powder in an aqueous solution, a mercapto compound is used as a reducing agent at a suitable pH range (i.e., from 3 to 10); the mercapto compound undergoes oxidation-reduction with the elemental sulfur powder to generate the divalent sulfide ions, which further react with the divalent mercury ions to generate the mercury sulfide precipitation. In this way, the mercury pollution related to the divalent mercury ions is treated.

In the present disclosure, the mercapto group of the mercapto compound has a great bondability with the divalent mercury ions. Compared with other reducing agents, such as ascorbic acid, this compound could avoid the reduction of the divalent mercury ions in an aqueous solution into elemental mercury.

In the present disclosure, the mercapto group of the mercapto compound has a great bondability with the divalent mercury ions, such that the compound could be used to remove divalent inorganic mercury adsorbed on the surface of the material. Therefore, the method according to the present disclosure could be used for the treatment of mercury pollution related to divalent inorganic mercury on the surface of materials as well as in the aqueous solutions.

### BRIEF DESCRIPTION OF THE DRAWINGS

FIG. 1 shows a histogram of a mercury concentration in Example 1.

FIG. 2 shows a physical picture of each group in Example 1.

FIG. 3 shows a histogram of a mercury concentration in Example 2.

FIG. 4 shows a histogram of a soluble mercury concentration in Example 3.

FIG. 5 shows a histogram of a mercury concentration in Example 4.

FIG. 6 shows a histogram of a mercury concentration when using a sulfur powder of 3 μm to 5 μm in Example 5.

FIG. 7 shows a histogram of a mercury concentration when using a sulfur powder of 150 μm in Example 5.

FIG. 8 shows a histogram of a mercury concentration in Example 6.

FIG. 9 shows physical pictures of removing Hg²⁺ on surfaces of 8 different particles in Example 7.

### DETAILED DESCRIPTION OF THE EMBODIMENTS

The present disclosure provides a method for removing a divalent inorganic mercury, including the following steps:
mixing a mercapto reagent, a sulfur powder, and a matrix with the divalent inorganic mercury to be removed to obtain a mixture, subjecting the mixture to reaction at a pH value of 3 to 10, wherein the mercapto reagent includes at least one selected from the group consisting of 2-mercaptoethanol, L-cysteine, and glutathione.

In some embodiments of the present disclosure, subjecting the mixture to reaction is performed at the pH value of 6 to 8. In specific examples, the pH value is specifically 3, 4, 5, 6, 7, 8, 9, or 10.

In some embodiments of the present disclosure, the pH value is achieved by adding a buffer salt. In some embodiments, the buffer salt includes a phosphate-buffered saline (PBS). In some embodiments, the PBS has a pH value of 6 to 10.

In some embodiments of the present disclosure, a pH measuring product, preferably a pH test paper is further used to avoid mercury contamination of the pH measuring equipment.

In some embodiments of the present disclosure, a molar ratio of a mercapto group in the mercapto reagent to Hg²⁺ in the matrix with the divalent inorganic mercury to be removed is in a range of (2.5-3): 1. A mercapto compound is used as a reducing agent. The mercapto compound and an elemental sulfur powder undergo oxidation-reduction to generate divalent sulfide ions, which then react with divalent mercury ions to form a mercury sulfide precipitation, thereby achieving the treatment of mercury pollution related to divalent mercury ions. Moreover, the mercapto group of the mercapto compound has a great bondability with the divalent mercury ions, which further avoids the reduction of the divalent mercury ions in an aqueous solution into elemental mercury compared with other reducing agents. In addition, the mercapto compound could also be used to remove divalent inorganic mercury adsorbed on a surface of material(s).

In some embodiments of the present disclosure, the sulfur powder has a particle size of 3 μm to 300 μm, and preferably 5 μm to 150 μm.

In some embodiments of the present disclosure, a molar ratio of the sulfur powder to Hg²⁺ in the matrix with the divalent inorganic mercury to be removed is in a range of (40-300): 1. The elemental sulfur powder is used to generate divalent sulfide ions, which are then combined with the divalent mercury ions to generate a mercury sulfide precipitation, thereby achieving the treatment of mercury pollution related to the divalent inorganic mercury.

In some embodiments of the present disclosure, under the condition that the sulfur powder has a particle size of 3 μm to 5 μm, a molar ratio of the sulfur powder to Hg²⁺ in the matrix with the divalent inorganic mercury to be removed is in a range of (80-120):1. In some embodiments, under the condition that the sulfur powder has a particle size of 150 μm to 300 μm, a molar ratio of the sulfur powder to Hg²⁺ in the matrix with the divalent inorganic mercury to be removed is in a range of (240-300): 1.

The principle of the present disclosure is explained below taking the L-cysteine as an example.

The L-cysteine reduces the sulfur powder to S²⁻. This reaction could be performed under mild conditions and is rapid in process. The generated S²⁻ has a great bondability with Hg²⁺ forming insoluble HgS. Such reaction could achieve harmless treatment of the Hg²⁺. A reaction equation in which the L-cysteine reduces the sulfur powder to the S²⁻ is shown in formula I:

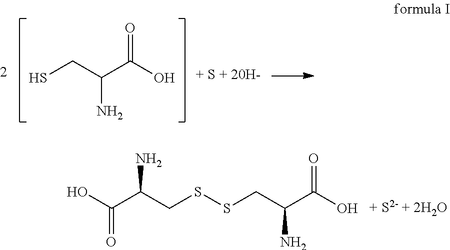

In some embodiments of the present disclosure, the matrix with the divalent inorganic mercury to be removed is selected from the group consisting of an aqueous solution containing the divalent inorganic mercury, and a material with the divalent inorganic mercury on a surface thereof.

In some embodiments of the present disclosure, the aqueous solution containing the divalent inorganic mercury is an aqueous solution of mercury chloride.

In some embodiments of the present disclosure, under the condition that the matrix with the divalent inorganic mercury to be removed is the aqueous solution containing the divalent inorganic mercury, the method includes

adding the mercapto reagent and the sulfur powder into the aqueous solution containing the divalent inorganic mercury, leaving a resulting mixture to stand to form a mercury sulfide precipitation, and conducting solid-liquid separation.

In specific examples of the present disclosure, the method includes the following steps: step I, dissolving the buffer salt into the aqueous solution containing the divalent inorganic mercury and mixing evenly; step II, measuring a pH value of a solution obtained, and proceeding to next step when the pH value is within a range of 6 to 8; step III, according to a molar content of total mercury in the solution obtained, adding a 2.5 to 3 fold molar excess of the mercapto compound and a 40 to 120 fold molar excess of the elemental sulfur powder, and mixing evenly; step IV, leaving a resulting mixture to stand to generate a mercury sulfide precipitate until a mercury content in liquid phase is less than 10 μg/L, and then separating the liquid phase from the precipitate; and step V, directly burying the precipitate containing mercury sulfide and excess elemental sulfur powder deep.

In some embodiments of the present disclosure, the mixing in step III is conducted at 30 rpm. In some embodiments, the mixing in step III is conducted for 10 min. In some embodiments, the mixing in step III is conducted at room temperature.

In some embodiments of the present disclosure, the mixing in step I and the mixing in step III are each conducted in a long-axis mixer.

In some embodiments, leaving to stand is conducted for 12 h. In some embodiments of the present disclosure, leaving to stand is conducted at room temperature.

In some embodiments of the present disclosure, under the condition that the matrix with the divalent inorganic mercury to be removed is the material with the divalent inorganic mercury on the surface thereof, the method includes:
mixing an aqueous solution of a buffer salt with the mercapto reagent to obtain a mercapto reagent solution; and
washing the surface of the material in the mercapto reagent solution, adding the sulfur powder thereto, leaving a resulting mixture to stand to form a mercury sulfide precipitation, and conducting solid-liquid separation.

In specific examples of the present disclosure, the method includes the following steps: step i, dissolving a buffer salt in water to prepare the aqueous solution of the buffer salt; step ii, preparing the mercapto reagent solution using the aqueous solution of the buffer salt; step iii, washing the surface of the material to be treated in the mercapto reagent solution; step iv, adding the sulfur powder thereto, leaving a resulting mixture to stand to generate a mercury sulfide precipitate until a mercury content in liquid phase is less than 10 μg/L, and then separating the liquid phase from the precipitate; and step v, directly burying the precipitate containing mercury sulfide and excess elemental sulfur powder deep.

In some embodiments of the present disclosure, under the condition that the matrix with the divalent inorganic mercury to be removed is the material with the divalent inorganic mercury on the surface thereof, the method includes
mixing an aqueous solution of a buffer salt, the mercapto reagent, and the sulfur powder to obtain a suspension including the sulfur powder and a mercapto compound; and
washing the surface of the material in the suspension including the sulfur powder and the mercapto compound, leaving a resulting mixture to stand to form a mercury sulfide precipitation, and conducting solid-liquid separation.

In specific examples of the present disclosure, the method includes the following steps: step 1, dissolving a buffer salt in water to prepare the aqueous solution of the buffer salt; step 2, preparing a suspension including the sulfur powder and the mercapto compound with the aqueous solution of the buffer salt; step 3, washing the surface of the material to be treated with the suspension including the sulfur powder and the mercapto compound, leaving a resulting mixture to stand to generate a mercury sulfide precipitate until a mercury content in liquid phase is less than 10 μg/L, and then separating the liquid phase from the precipitate; and step 4, directly burying the precipitate including mercury sulfide and excess elemental sulfur powder deep.

In the present disclosure, the removal efficiency could be improved by using the suspension including the sulfur powder and the mercapto compound.

To further illustrate the present disclosure, the method for removing a divalent inorganic mercury according to the present disclosure is described in detail below in conjunction with examples, but these examples should not be construed as limiting the claimed scope of the present disclosure.

### Example 1: Effect of L-Cysteine, Mercaptoethanol, and Ascorbic Acid Separately in Combination with Sulfur Powder on Converting Hg²⁺-State Mercury in Aqueous Solution into Mercury Sulfide

### Example Effects

When the mercaptoethanol and the L-cysteine were used in combination with the sulfur powder separately, the mercury chloride in a PBS solution could be converted into a black mercury sulfide precipitate. The ascorbic acid could reduce the mercury chloride in the PBS solution into elemental mercury, and when being in combination with the sulfur powder, the ascorbic acid resulted in that black mercury sulfide precipitate generated was less than that of the mercaptoethanol and the L-cysteine, each in combination with the sulfur powder.

### Experiment Procedures

To 50 ml conical-bottom centrifuge tubes with or without 150 mg of a 100 mesh sulfur powder, 24 mL of ultrapure water, L-cysteine solution (200 μg/mL), ascorbic acid solution (300 μg/mL), and mercaptoethanol solution (200 μg/mL), which all were prepared using PBS, were added separately, and 1 mL of a 500 μg/mL mercuric chloride solution was added to make a total volume of the resulting solution be 25 mL. A resulting mixture in each conical-bottom centrifuge tube was mixed to be uniform at 30 rpm for 3 h, and left to stand for 1 h. 1.0 mL of liquid was sampled 1 cm below a liquid surface and transferred into a 1.5 mL centrifuge tube, and then diluted to determine a mercury content therein.

### Experimental Results

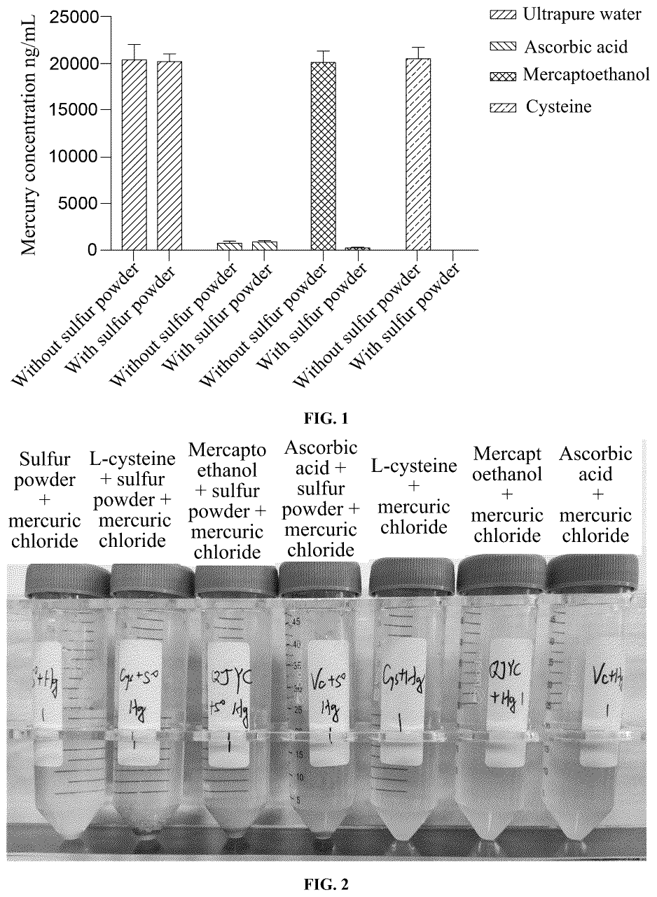

A mercury concentration in the PBS solution was 20,000 ng/mL. When the sulfur powder, mercaptoethanol, and cysteine were used separately alone, the mercury content in the PBS solution did not change. When the mercaptoethanol and L-cysteine were used in combination with the sulfur powder separately, the black mercury sulfide precipitate was generated in the PBS solution, and a soluble mercury content dropped to 165.27 ng/ml and 136.36 ng/mL, respectively. The ascorbic acid alone reduced the mercury in the PBS solution into elemental mercury (the solution showed light pink), and the soluble mercury content dropped to 760.85 ng/mL. When the ascorbic acid was used in combination with sulfur powder, the black mercury sulfide precipitate generated in the solution was less than that of the mercaptoethanol, L-cysteine, each in combination with sulfur powder, and the soluble mercury content dropped to 833.43 ng/mL. The experimental results are shown in FIG. 1.

FIG. 2 shows a physical picture of each group in Example 1.

### Example 2: Effect of pH Value on the Conversion of Hg²⁺-State Mercury in Aqueous Solution into Insoluble Mercury Using the Combination of L-Cysteine and Sulfur Powder

### Example Effects

When the pH value was in the range of 6 to 10, the combination of L-cysteine and sulfur powder had the best effect of converting Hg²⁺-state mercury in the aqueous solution into insoluble mercury sulfide.

### Experiment Procedures

To 50 mL centrifuge tubes, 0.3 mL of a 0.1 mg/mL divalent inorganic mercury solution was added separately, and then 30 mL of buffer solutions (each containing 30 mg of sulfur powder with a particle size of 150 μm and L-cysteine at a concentration of 50 μg/mL, having pH values of 1.2, 2.0, 3.0, 4.0, 5.0, 6.0, 7.0, 8.0, 9.0, and 10.0, respectively) were added thereto separately, each group having 3 parallel controls. A resulting mixture in each centrifuge tube was mixed to be uniform with a long-axis mixer at 30 rpm for 4 h, and left to stand for 12 h. 0.5 mL of a resulting supernatant was collected, and a total mercury content thereof was measured using a Milestone DMA-80 direct mercury analyzer.

### Experimental Results

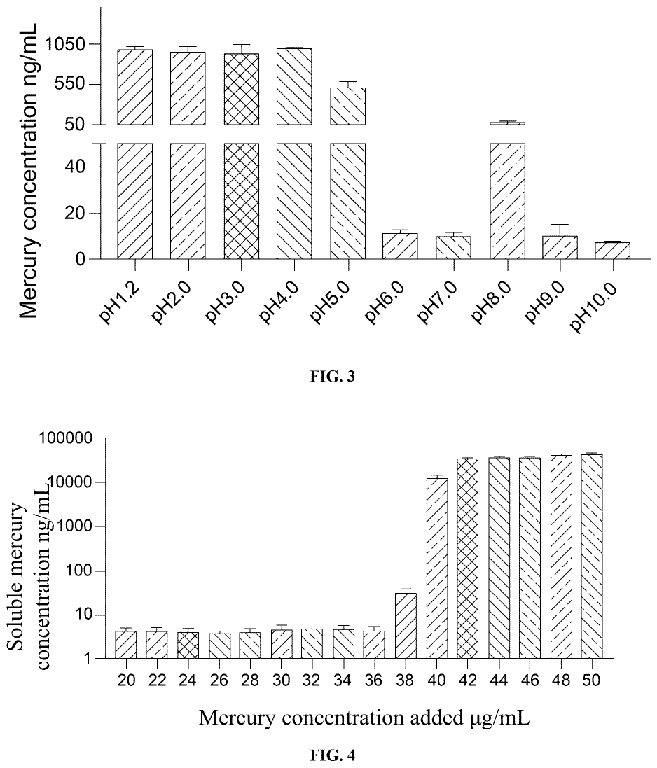

After the above treatment, the total mercury concentration in each buffer solution is shown in FIG. 3. The mercury concentration in each prepared solution was 1,000 ng/mL. As the pH value increased to reach a pH value of 5.0, the soluble mercury concentration in the solution decreased. In the pH range of 6.0 to 10.0, the mercury concentration was lower than 90 ng/mL, which were 11.35 ng/mL, 10.16 ng/ml, 85.57 ng/mL, 9.89 ng/mL, and 7.04 ng/mL, respectively.

### Example 3: Effect of Molar Ratio of L-Cysteine to Hg²⁺ on the Conversion of Hg²⁺-State Mercury in Aqueous Solution into Insoluble Mercury Using the Combination of L-Cysteine and Sulfur Powder

### Example Effects

When the molar ratio of L-cysteine to Hg²⁺ was greater than 2, the combination of L-cysteine and sulfur powder had the best effect of converting Hg²⁺-state mercury in aqueous solution into insoluble mercury sulfide. Considering the oxidative loss of L-cysteine, the molar ratio of L-cysteine to Hg²⁺ was recommended to be greater than 2.5 in practical applications.

### Experiment Procedures

To 50 mL centrifuge tubes, different volumes of divalent inorganic mercury solutions were added separately, and then ultrapure water was added to make a total volume at 15 mL. 15 mL of a solution with a pH value of 6.0 (containing 300 mg of sulfur powder (3 μm to 5 μm) and L-cysteine at a concentration of 100 μg/mL) was added thereto, such that total mercury concentrations in the solutions were 20, 22, 24, 26, 28, 30, 32, 34, 36, 38, 40, 42, 44, 46, 48, and 50 μg/mL, respectively. 3 parallel controls were set in each group. A resulting mixture in each centrifuge tube was mixed to be uniform with a long-axis mixer at 30 rpm for 10 min, and left to stand for 20 min. 1.3 mL of a resulting supernatant was collected and centrifuged at 15,000 rpm for 20 min. 0.5 mL of a resulting supernatant was collected, and a total mercury content was measured using a Milestone DMA-80 direct mercury analyzer.

### Experimental Results

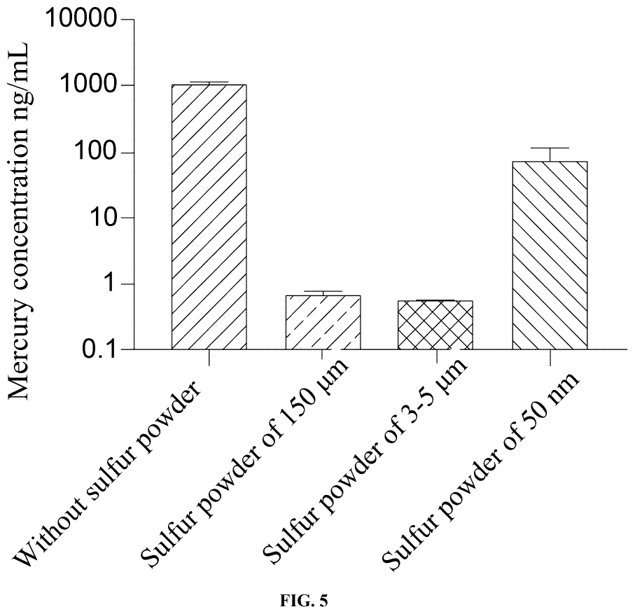

After the above treatment of mercury solutions with different concentrations, the soluble mercury concentration is shown in FIG. 4. When the mercury concentration was not larger than 36 μg/mL, the total mercury concentration in the solution was less than 5 ng/ml; when the mercury concentration was increased to reach 38 g/mL, the soluble mercury began to increase significantly. The mercury concentration and L-cysteine concentration were converted into molarity, i.e., the mercury concentration of 36 μg/mL corresponded to a molarity of 0.1795 mM, and the L-cysteine concentration of 50 μg/mL corresponded to a molarity of 0.4127 mM. Taking into account the oxidative loss of L-cysteine, it was deduced that the molar ratio of L-cysteine to Hg²⁺ was 2:1. In actual use, in order to ensure the conversion rate of soluble mercury in the solution into insoluble mercury, it was recommended that a ratio of L-cysteine to Hg²⁺ for reaction be not less than 2.5.

### Example 4: Effect of Sulfur Powder Particle Size on the Conversion of Hg²⁺-State Mercury in Aqueous Solution into Insoluble Mercury Using the Combination of L-Cysteine and Sulfur Powder

### Example Effects

Sulfur powder with a particle size of 3 μm to 5 μm or 150 μm has a better effect in converting Hg²⁺-state mercury in aqueous solution into insoluble mercury sulfide than that of sulfur powder with a particle size of 50 nm.

### Experiment Procedures

To 50 mL centrifuge tubes, 0.3 mL of a 0.1 mg/mL divalent inorganic mercury solution was added separately, and then 30 mL of buffer solutions with pH value of 6.0 (containing 30 mg of sulfur powder with particle size 150 μm, 3 μm to 5 μm, and 50 nm respectively, as well as L-cysteine at a concentration of 50 μg/mL) were added thereto separately, each group having 3 parallel controls. A resulting mixture in each centrifuge tube was mixed to be uniform with a long-axis mixer at 30 rpm for 4 h, and left to stand for 12 h. 0.5 mL of a resulting supernatant was collected, and a total mercury content thereof was measured using a Milestone DMA-80 direct mercury analyzer.

### Experimental Results

After the above treatment, the total mercury concentration in each solution is shown in FIG. 5. Compared with those without sulfur powder, the addition of sulfur powder with different particle sizes to solutions resulted in a significantly dropped mercury concentration. The addition of sulfur powder with a particle size of 3 μm to 5 μm to solutions achieved the lowest total mercury concentration, i.e., 0.55 ng/ml; the second lowest was the solution containing sulfur powder with a particle size of 150 μm, being 0.64 ng/ml; the solution containing sulfur powder with a particle size of 50 nm had the highest total mercury concentration, at 72.77 ng/mL. The experimental results showed that the role of sulfur powder included two aspects: reacting with L-cysteine to generate S²⁻; and adsorbing the mercury sulfide generated by the reaction to accelerate the sedimentation process.

### Example 5: Molar Ratio of Sulfur Powder with Different Particle Sizes to Hg²⁺ on the Conversion of Hg²⁺-State Mercury in Aqueous Solution into Insoluble Mercury Using the Combination of L-Cysteine and Sulfur Powder

### Example Effects

When sulfur powder with particle sizes of 3 μm to 5 μm or 150 μm converted Hg²⁺-state mercury in aqueous solution into insoluble mercury sulfide, the molar ratio of sulfur powder to L-cysteine should be greater than 80 or greater than 240, respectively.

### Experiment Procedures

To 50 mL centrifuge tubes, 1 mL of a 0.5 mg/mL mercury solution was added separately. 29 mL of buffer solutions with a pH value of 6.0 (containing 2 mg, 5 mg, 10 mg, 20 mg, 30 mg, 40 mg, 50 mg, 60 mg of sulfur powder with a particle size of 3 μm to 5 μm respectively, as well as L-cysteine at a concentration of 25 μg/mL), or 29 mL of buffer solutions with a pH value of 6.0 (containing 40 mg, 60 mg, 80 mg, 100 mg, 140 mg, 180 mg of sulfur powder with a particle size of 150 μm, respectively, as well as L-cysteine at a concentration of 25 μg/mL) were added thereto separately, each group having 3 parallel controls. A resulting mixture in each centrifuge tube was mixed to be uniform with a long-axis mixer at 30 rpm for 10 min, 30 min, 1 h, 2 h, and 4 h, and left to stand for 20 min. 1.3 mL of a resulting supernatant was collected and centrifuged at 15,000 rpm for 20 min. 0.5 mL of a resulting supernatant was collected, and a total mercury content thereof was measured using a Milestone DMA-80 direct mercury analyzer.

### Experimental Results

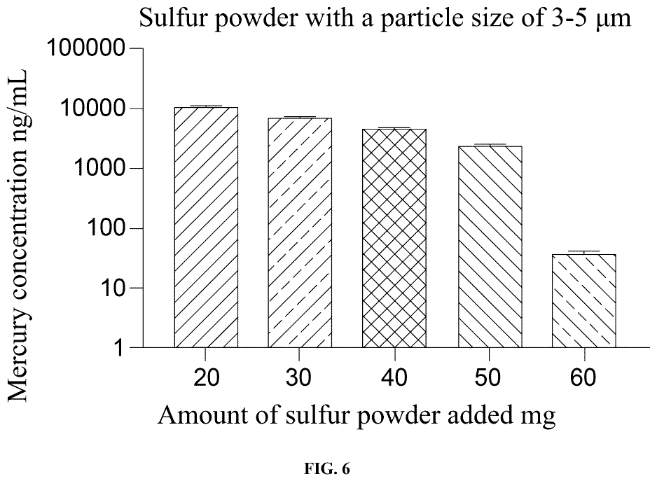

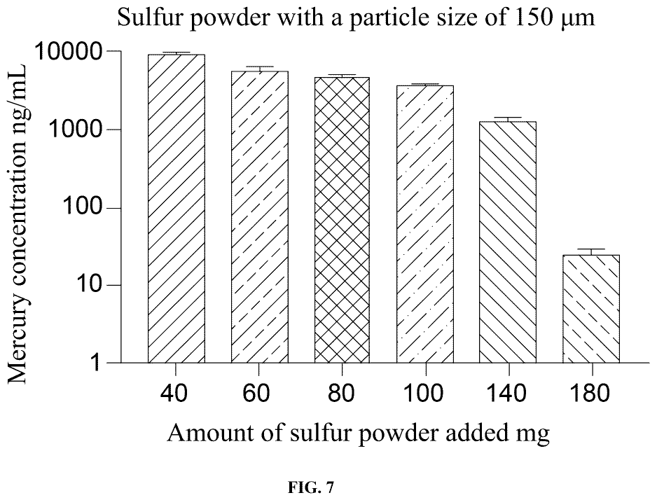

After the above treatment, total mercury concentrations in solutions are shown in FIG. 6 to FIG. 7. The soluble mercury content in the solution before treatment was approximately 16.67 μg/mL. When sulfur powder with a particle size of 3 μm to 5 μm was added in an amount of greater than 60 mg, the total mercury concentration in the solution decreased by not less than 99% and was lower than 40 ng/ml; When sulfur powder with a particle size of 150 μm was added in an amount of greater than 180 mg, the total mercury concentration in the solution decreased by not less than 99% and was lower than 25 ng/mL. When the concentration of L-cysteine was 25 μg/mL, the molar ratio of sulfur powder with a particle size of 3 μm to 5 μm or 150 μm to L-cysteine should be greater than 80 or greater than 240, respectively.

### Example 6; Effect of Treatment Time on the Conversion of Hg²⁺-State Mercury in Aqueous Solution into Insoluble Mercury Using the Combination of L-Cysteine and Sulfur Powder

### Example Effects

The combination of L-cysteine and sulfur powder was used with a treatment time of more than 10 min, which could convert Hg²⁺-state mercury in the aqueous solution into insoluble mercury sulfide with a reaction rate of more than 99.5%.

### Experiment Procedures

To 50 mL centrifuge tubes, 0.3 mL of a 0.1 mg/mL divalent inorganic mercury solution was added separately. 30 mL of buffer solutions with pH value of 6.0 (containing 30 mg of sulfur powder with particle size 3 μm to 5 μm and L-cysteine at a concentration of 50 μg/mL) were added thereto separately, each group having 3 parallel controls. A resulting mixture in each centrifuge tube was mixed to be uniform with a long-axis mixer at 30 rpm for 10 min, 1 h, 2 h, and 4 h, and left to stand for 20 min. 1.3 mL of a resulting supernatant was collected and centrifuged at 15,000 rpm for 20 min. 0.5 mL of a resulting supernatant was collected, and a total mercury content thereof was measured using a Milestone DMA-80 direct mercury analyzer.

### Experimental Results

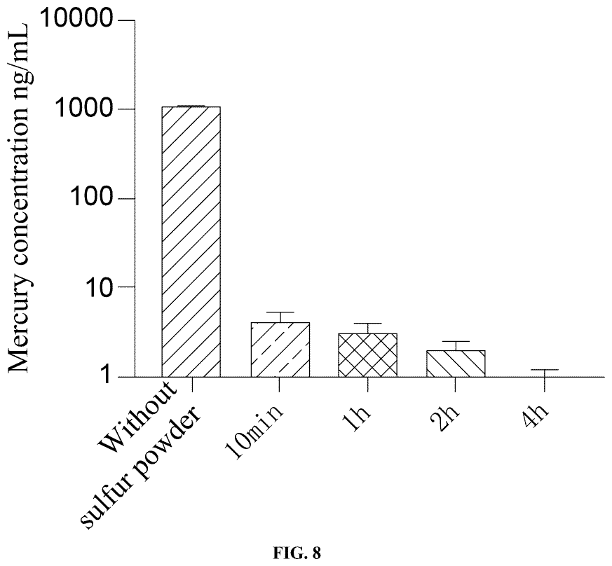

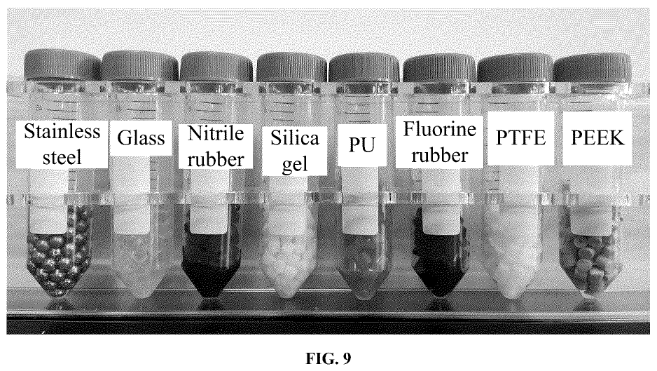

After the above treatment, the total mercury concentrations in the solutions after different mixing times are shown in FIG. 8. With different mixing times, the conversion rate of soluble mercury into insoluble mercury increased over time. When the total mercury concentration in the solution was less than 5 ng/mL, the conversion rate of soluble mercury into insoluble mercury was greater than 99.5%. This indicated that the reaction proceeded quickly and did not need a large energy consumption for mixing.

### Example 7: Comparison Between L-Cysteine Solution in PBS and 5 wt % Hydrochloric Acid in Terms of the Hg²⁺ Scavenging Effect on the Material Surface

### Example Effects

A cleaning effect of the L-cysteine solution in PBS on stainless steel, glass, silica gel, nitrile rubber, polyurethane (PU), polyetheretherketone (PEEK), and plastics was better than or equivalent to that of 5 wt % aqueous hydrochloric acid solution.

### Experiment Procedures

Materials: stainless steel ball having a diameter of 6 mm; glass ball having a diameter of 6.1 mm; nitrile rubber cylindrical particles having a diameter and column height being both 5 mm; silica gel cylindrical particles having a diameter and column height being both 5 mm; PU cylindrical particles having a diameter and column height being both 6 mm; fluorine rubber cylindrical particles having a diameter and column height being both 5 mm; polytetrafluoroethylene (PTFE) cylindrical particles having a diameter and column height being both 5 mm; PEEK cylindrical particles having a diameter and column height being both 5.6 mm; and plastic centrifuge tube (50 mL)

Washing solution: ultrapure water, 5 wt % aqueous HCl solution, and 200 μg/mL L-cysteine solution in PBS

(1) The above 8 types of particles (excluding plastic) were washed separately 3 times with 200 μg/mL L-cysteine solution in PBS in 50 mL centrifuge tubes.

(2) The particles were washed with 30 mL of ultrapure water 5 times to remove residual L-cysteine. A mercury content in the liquid obtained after washing was measured, wherein the mercury concentration therein should be less than 20 ng/mL.

(3) 300 mL of 2 mg/mL mercury solution was prepared with ultrapure water.

(4) the above 8 types of particles (in total 100 particles) were added separately to 50 ml centrifuge tubes, while to one of the centrifuge tubes, no particles were added, and therefore there were a total of 9 centrifuge tubes.

(5) 30 mL of 2 mg/mL divalent inorganic mercury solution was added to each centrifuge tube, and a resulting mixture in each tube was mixed to be uniform with a long-axis rotating mixer at 10 rpm for 1 h, and left to stand and particles were soaked therein for 49 h.

(6) The particles were washed 5 times with 30 mL ultrapure water to remove high-concentration mercury solution.

(7) The above 8 types of particles were poured into disposable bacterial culture dishes, particles of one type were divided into 3 tubes, and transferred to 50 mL centrifuge tubes. For each type of 5 mm columnar particles, 30 particles were taken; for each type of 6 mm columnar particles, 21 particles were taken; for each type of 5.6 mm columnar particles, 24 particles were taken; for each type of 6 mm spherical particles, 27 particles were taken; and for each type of 6.1 mm spherical particles, 26 particles were taken. 3 of the 50 mL centrifuge tubes for soaking were taken as experimental objects of plastic materials.

(8) 25 mL each of ultrapure water, 5 wt % HCl, and 200 μg/mL cysteine solution in PBS were added to 3 centrifuge tubes of each type of particles, respectively, and particles therein were washed using a long-axis rotating mixer by soaking for 4 h at 30 rpm.

(9) After stopping washing, 1 portion of the solution in each centrifuge tube was transferred into a 1.5 mL centrifuge tube, 1 portion being 1 mL.

(10) The mercury content was determined with a DMA-80 mercury analyzer.

### Experimental Results

After the above treatment, the total mercury concentrations in the resulting liquids obtained from washing were shown in Table 1. The cleaning effect of 200 μg/mL L-cysteine solution in PBS on 9 materials was better than that of ultrapure water, and the cleaning effect thereof on stainless steel, glass, and silica gel was better than that of 5% aqueous hydrochloric acid solution; the cleaning effect thereof on nitrile rubber, PU, PEEK, and plastics was equivalent to that of 5% aqueous hydrochloric acid solution; and the cleaning effect thereof on fluorine rubber and PTFE was not as good as that of 5% aqueous hydrochloric acid solution.

FIG. 9 shows physical pictures of Hg²⁺ removal on surfaces of 8 different particles.

TABLE 1
Comparison between L-cysteine solution in PBS and 5 wt % hydrochloric acid in
terms of the Hg²⁺ scavenging effect on the material surface

| | | | | Cleaning | |
|---|---|---|---|---|---|
| | | 5% | | efficiency | Cleaning |
| | | aqueous | L-cysteine | compared | efficiency |
| | | HCl | solution | with | compared with |
| | Ultrapure | solution | in PBS | ultrapure | 5% aqueous |
| | water | ng/mL | ng/ml | water % | HCl solution % |
| Stainless steel ball | 254.24 | 266.46 | 907.38 | 356.90 | 340.52 |
| Glass ball | 2144.11 | 3154.56 | 3561.68 | 166.11 | 112.91 |
| Nitrile rubber cylindrical | 63820.45 | 85015.61 | 86405.33 | 135.39 | 101.63 |
| particles | | | | | |
| Silica gel cylindrical | 4456.33 | 9761.84 | 16276.05 | 365.23 | 166.73 |
| particles | | | | | |
| PU cylindrical particles | 34106.82 | 52879.60 | 51869.40 | 152.08 | 98.09 |
| Fluorine rubber | 9552.80 | 18705.31 | 13489.17 | 141.21 | 72.11 |
| cylindrical particles | | | | | |
| PTFE cylindrical particles | 45.83 | 132.36 | 114.30 | 249.38 | 86.36 |
| PEEK cylindrical | 317.76 | 642.72 | 683.49 | 215.10 | 106.34 |
| particles | | | | | |
| Plastic centrifuge tube | 2890.26 | 3970.70 | 4243.44 | 146.82 | 106.87 |

### Example 8: Comparison Between an Aqueous Solution of the Combination of L-Cysteine and Sulfur Powder and 5 wt % Hydrochloric Acid in Terms of the Hg²⁺ Scavenging Effect on the Surface of Silica Gel

### Example Effects

The combination of L-cysteine and elemental sulfur powder was used with a treatment time of more than 10 min, which could convert Hg²⁺-state mercury in the aqueous solution into insoluble mercury sulfide with a reaction rate of more than 99.5%.

### Experiment Procedures

(1) 100 mL of 2 mg/mL divalent inorganic mercury solution was prepared with ultrapure water.

(2) 100 silica gel particles were added to 50 mL centrifuge tubes, respectively.

(3) 30 mL of 2 mg/mL a divalent inorganic mercury solution was added to each tube, and a resulting mixture in each tube was mixed to be uniform using a long-axis rotating mixer at 10 rpm for 1 h, and left to stand and particles were soaked therein for 49 h.

(4) The particles were washed 5 times with 30 mL ultrapure water to remove high-concentration mercury solution.

(5) The silica gel particles in Example 7 were poured into a disposable bacterial culture dish, divided into 4 tubes, 25 particles for each tube, and transferred into a 50 mL centrifuge tube.

(6) 25 mL each of ultrapure water, 5 wt % HCl, and 200 μg/mL cysteine solution in PBS, and 200 μg/mL cysteine solution in PBS+200 mg elemental sulfur powder with a particle size of 3 μm to 5 μm were added to 4 centrifuge tubes, respectively, and separately washed using a long-axis rotating mixer by soaking for 4 h at 30 rpm.

(7) After stopping washing, the silica gel particles were transferred into a new 50 mL centrifuge tube.

(8) The mercury content of a single silica gel particle was determined with a DMA-80 mercury analyzer.

### Experimental Results

After the above treatment, the total mercury concentration of the silica gel particles was shown in Table 2. The total mercury content of silica gel particles after washing with 200 μg/mL cysteine solution in PBS+200 mg elemental sulfur with a particle size of 3 μm to 5 μm was lower than that of washing with the ultrapure water, 5 wt % hydrochloric acid, and 200 μg/mL L-cysteine solution in PBS.

TABLE 2
Comparison between the combination of L-cysteine and sulfur powder and 5 wt %
hydrochloric acid in terms of Hg²⁺ scavenging effect on the surface of the material

| | | Washing with | | Washing with |
|---|---|---|---|---|
| | | 5% hydrochloric | | L-cysteine + |
| | Washing with water | acid | Washing with L-cysteine | sulfur powder |
| Mercury content of | 563.69 | 235.88 | 152.45 | 42.37 |
| silica gel particles/ | | | | |
| ng | | | | |

The above described are merely preferred embodiments of the present disclosure rather than limitations to the present disclosure in any form. It should be noted that those of ordinary skill in the art may further make several improvements and modifications without departing from the principle of the present disclosure, but such improvements and modifications should be deemed as falling within the scope of the present disclosure.

What is claimed is:

1. A method for removing a divalent inorganic mercury, comprising the steps of
mixing a mercapto reagent, a sulfur powder, and a matrix with the divalent inorganic mercury to be removed to obtain a mixture, and subjecting the mixture to reaction at a pH value of 3 to 10,
wherein the mercapto reagent comprises one or more selected from the group consisting of 2-mercaptoethanol, cysteine, and glutathione.

2. The method as claimed in claim 1, wherein subjecting the mixture to reaction is performed at the pH value of 6 to 8.

3. The method as claimed in claim 1, wherein a molar ratio of a mercapto group in the mercapto reagent to Hg²⁺ in the matrix with the divalent inorganic mercury to be removed is in a range of (2.5-3):1.

4. The method as claimed in claim 1, wherein the sulfur powder has a particle size of 3 μm to 300 μm.

5. The method as claimed in claim 4, wherein the sulfur powder has a particle size of 5 μm to 150 μm.

6. The method as claimed in claim 1, wherein a molar ratio of the sulfur powder to Hg²⁺ in the matrix with the divalent inorganic mercury to be removed is in a range of (40-300):1.

7. The method as claimed in claim 5, wherein under the condition that the sulfur powder has a particle size of 3 μm to 5 μm, a molar ratio of the sulfur powder to Hg²⁺ in the matrix with the divalent inorganic mercury to be removed is in a range of (80-120):1.

8. The method as claimed in claim 5, wherein under the condition that the sulfur powder has a particle size of 150 μm to 300 μm, a molar ratio of the sulfur powder to Hg²⁺ in the matrix with the divalent inorganic mercury to be removed is in a range of (240-300):1.

9. The method as claimed in claim 1, wherein the pH value is achieved by adding a buffer salt.

10. The method as claimed in claim 1, wherein the matrix with the divalent inorganic mercury to be removed is selected from the group consisting of an aqueous solution containing the divalent inorganic mercury, and a material with the divalent inorganic mercury on a surface thereof.

11. The method as claimed in claim 10, wherein under the condition that the matrix with the divalent inorganic mercury to be removed is the aqueous solution containing the divalent inorganic mercury, the method comprises
adding the mercapto reagent and the sulfur powder into the aqueous solution containing the divalent inorganic mercury, leaving a resulting mixture to stand to form a mercury sulfide precipitation, and conducting solid-liquid separation.

12. The method as claimed in claim 10, wherein under the condition that the matrix with the divalent inorganic mercury to be removed is the material with the divalent inorganic mercury on the surface thereof, the method comprises:
mixing an aqueous solution of a buffer salt with the mercapto reagent to obtain a mercapto reagent solution; and
washing the surface of the material in the mercapto reagent solution, adding the sulfur powder thereto, leaving a resulting mixture to stand to form a mercury sulfide precipitation, and conducting solid-liquid separation.

13. The method as claimed in claim 10, wherein under the condition that the matrix with the divalent inorganic mercury to be removed is the material with the divalent inorganic mercury on the surface thereof, the method comprises
mixing an aqueous solution of a buffer salt, the mercapto reagent, and the sulfur powder to obtain a suspension comprising the sulfur powder and a mercapto compound; and
washing the surface of the material in the suspension comprising the sulfur powder and the mercapto compound, leaving a resulting mixture to stand to form a mercury sulfide precipitation, and conducting solid-liquid separation.

14. The method as claimed in claim 4, wherein a molar ratio of the sulfur powder to Hg2+ in the matrix with the divalent inorganic mercury to be removed is in a range of (40-300):1.

15. The method as claimed in claim 2, wherein the pH value is achieved by adding a buffer salt.
